(19) United States
(12) Patent Application Publication
(10) Pub. No.: US 2006/0161665 A1
(43) Pub. Date: Jul. 20, 2006

(54) Method of automatically logging in a website

(76) Inventor: Hung-Chou Tsai, Nantou County (TW)

Correspondence Address: Hung-Chou Tsai, 9F., No. 37, Dongsing Road, Xinyi District, Taipei City, 110, TW

(21) Appl. No.: 11/034,785

(22) Filed: Jan. 14, 2005

(51) Int. Cl. G06F 15/16

(52) U.S. Cl. 709/229; 709/227

(57) ABSTRACT

In a method of automatically logging in a website, a computer system is powered on and then automatically opens a browser and inputs a user's personal information to log in at least one website without any user operation. The method includes the steps of (1) initializing a computer system that allows connection of a removable storage device thereto, so that the computer system is able to automatically log in a website; (2) Determining whether there is any information in connection with websites allowing the user to log in, and entering any required information or automatically logging in the websites; and (3) ending the login.

### FIELD OF THE INVENTION

The present invention relates to a method of automatically logging in a website, and more particularly to a method for a powered-on computer system to automatically open a browser and input user's personal information and then log in at least one website, so that a user does not need to manually open the browser, locate the website to be logged in, and complete necessary login procedures.

### BACKGROUND OF THE INVENTION

The third industrial revolution in the computer field has brought prosperous developments in the virtual world of network. With its diversification, comprehensiveness, and real-time processing ability, the virtual world of network not only becomes the most welcomed tool among all trades to realize tremendous commercial opportunities, but also provides useful functions in recreational, educational, and mass media fields. It would never be overstated that the virtual world of network is richer than the real world in terms of the above-mentioned advantages.

As a result, there are people in all kinds of fields, including professionals and students in educational and researching institutes, young and old people seeking for exciting, funny, and time-killing things, pressmen, bankers, and enterprisers, who log on different websites everyday, from knowledge, recreational, mass media to commercial websites, to locate and obtain the information they need. However, many of the currently available websites could be logged in only when the user is a registered member and enters required personal information. While this measure provides protection to the members of the website, it also brings inconveniences to the users. It is very possible that a user registers different user names and passwords indifferent websites, and does not always remember what user name and password has been registered for what website. Therefore, there are times the user fails to input correct log in information and is rejected by a website to get information required in daily work. It is also possible that some high-rankers or people who are not so familiar with operating a computer system do not know how to successfully log in the desired websites.

In the disclosure of U.S. Pat. No. 6,496,855, it is taught a user may enter some personal information at a client computer, and the entered personal information is transmitted via a network system and stored in a database. When the user wants to log in a member-only website from a client computer, he or she may first enter the database to check the previously registered personal information before logging in the desired website. In this operation mode, the user may log in any desired website in a convenient and mobile manner. That is, with this operation mode, the user may log in a registered and frequently visited member-only website from any computer system simply by getting the registered personal information via a network system first. However, as a matter of fact, it is also very dangerous to store personal confidential information in some other computer system just for the purpose of retrieving such information via a network system at any time. There are chances the computer system having the personal confidential information stored therein is invaded by unauthorized users, and data packets containing these personal information are intercepted while being transferred over a network system.

It is therefore desirable to develop a method of automatically logging in a website to solve the above-mentioned problems.

### SUMMARY OF THE INVENTION

A primary object of the present invention is to provide a method of automatically logging in a website that enables a user to conveniently log in a registered and frequently visited member-only website whenever the user powers on his computer system. That is, the user's computer system, after being powered on, automatically logs in a website that is frequently visited by the user, and the user does not need to always remember or key in the confidential information registered for a specific member-only website.

Another object of the present invention is to provide a method of automatically logging in a website that allows parents to preset websites allowable for logging in, lest children should log in any website improper or unsuitable for them.

A further object of the present invention is to provide a method of automatically logging in a website that avoids the problem of invasion and accordingly unauthorized disclosure of user confidential information while such information is transferred over network or stored in other computer systems.

To achieve the above and other objects, the method of automatically logging in a website according to the present invention mainly includes the following steps:

1. initialize a computer system that allows connection of a removable storage device thereto, so that the computer system is able to automatically log in a website;

2. determine whether there is any information in connection with websites allowing the user to log in, and enter any required information or automatically log in the websites; and

3. end the login.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing steps included in the method of automatically logging in a website according to the present invention.

### DETAILED DESCRIPTION OF THE PREFERRED EMBODIMENTS

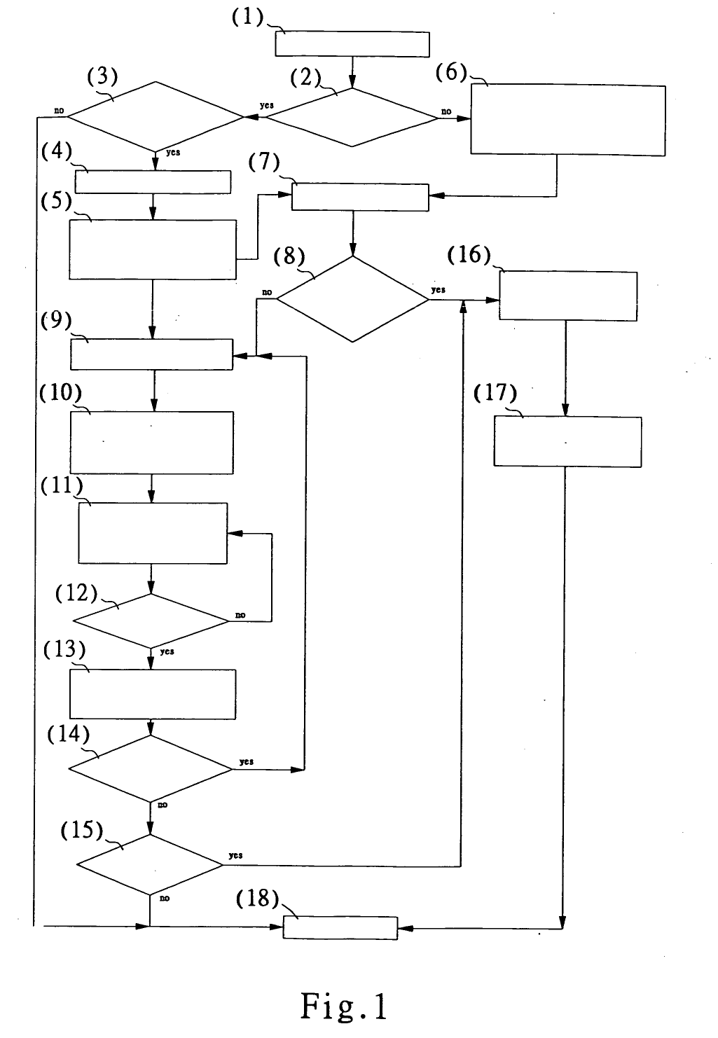

Please refer to FIG. 1 that is a flowchart showing steps included in a method of automatically logging in a website according to the present invention. As shown, the steps include:
(1) power on a computer system, such as a desktop computer, a notebook computer, or a personal digital assistant;
(2) determine through an operating system in the computer system whether there is a removable storage device externally connected to the computer system, if yes, go to step (3); and if not, go to step (6), the operating system may be anyone of Windows 98™, WindowsMe™, Windows2000™, and Windows XP™;
(3) check through the operating system in the computer system whether there is an Autorun.inf file in the externally connected removable storage device, if yes, go to step (4); and if not, go to step (18);
(4) open and run the Autorun.inf file;
(5) run a first program in the Autorun.inf file, the first program is able to drive specific software around the operating system capable of performing automatic opening and logging in of a website, then, go to step (7);
(6) open a second program through an auto-run program controlled via a Register key of the operating system, the second program is able to drive specific software around the operating system capable of performing automatic opening and logging in of a website, so as to perform the automatic opening and logging in of a website;
(7) drive the specific software through the first or the second program;
(8) detect through the specific software for any related data, with which the operating system automatically opens and logs in a related website, if no related data is detected, go to step (9); and if any related data is detected, go to step (16);
(9) display an interface for entering data enabling linking to the related website;
(10) manually enter by a user on the interface the data required to link to the website, procedures for login are immediately performed and a web page of the website to be logged in is displayed immediately;
(11) display an interface for entering further information about user, such as user name, user-specified password, etc., with which the user is admitted to an authorized-only web page of the website;
(12) test whether the entered further information about user is correct or not, if yes, go to step (13) and if not, go to step (11) again;
(13) store the data for linking to the related website and the further information about user in the externally connected removable storage device or the computer system;
(14) check and determine whether there is still any other new data for linking to other related website and any other further information about user to be entered, if yes, go to step (9) again; and if not, go to step (15);
(15) determine whether an immediate login of the desired website is to be done or not, if yes, go to step (16); and if not, go to step (18);
(16) load the data for linking to website and the further information about user from the externally connected removable storage device or the computer system;
(17) automatically display at least one desired website, and immediately automatically input the further information about user to log in the website; and
(18) end the login.

The method of automatically logging in a website according to the present invention is applicable to a computer system with or without any external USB hard disk or general CD-ROM, so that the computer system, once powered on, may be quickly linked to a website to be logged on. In the case the computer system is externally connectable to a removable storage device or a CD-ROM, the removable storage device or the CD-ROM may be then connected to any other computer system for the user to log in any desired or frequently visited website at any place and at any time. On the other hand, the method of the present invention also helps the aged or people who are not so skillful in operating a computer system to successfully log in some stock or financial websites. Moreover, the method of the present invention allows storage of only selected website addresses in the external storage device, such as USB mass storage device, personal digital apparatus, or general CD-ROM, to protect children or young men against unsuitable websites. The method of the present invention is also highly efficient and effective in terms of its simplified operation, which enables high-rankers or research fellows who need to frequently visit many different websites to move among different web pages quickly. Meanwhile, the method of the present invention allows a user to preset a plurality of websites to be logged in, and the user may register in these preset websites different user names and passwords for logging in the websites. This protects the preset websites against undesired invasion at the same time due to unauthorized disclosure of only one user name and password preset for all the selected websites.

In conclusion, the method of automatically logging in a website according to the present invention is novel and improved to satisfy different people, including the aged, those who are not familiar with computer operation, high-rankers, and research fellows, and to protect children and young men against undesired websites. Moreover, the method of the present invention is also industrial useful because any product derived from the present invention would no doubt satisfy the current market demands.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method of automatically logging in a website, comprising the steps of:
(1) initializing a computer system that allows external connection of a removable storage device thereto, so that the computer system is able to automatically log in a website;
(2) determining whether there is any information in connection with websites allowing the user to log in, so as to enter any required information or automatically log in the websites; and
(3) ending the login.

2. The method of automatically logging in a website as claimed in claim 1, wherein the step (1) further comprises the following steps:
(1-1) powering on the computer system;
(1-2) determining through an operating system in the computer system whether there is a removable storage device externally connected to the computer system; if yes, going to step (1-3); and if not, going to step (1-6);
(1-3) checking through the operating system in the computer system whether there is an Autorun.inf file in the externally connected removable storage device; if yes, going to step (1-4); and if not, going to step (3);
(1-4) opening and running the Autorun.inf file;
(1-5) running a first program in the Autorun.inf file; the first program being able to drive specific software around the operating system capable of performing automatic opening and logging in of a website; and then, going to step (1-7);
(1-6) opening a second program through an auto-run program controlled via a Register key of the operating system; the second program being able to drive specific software around the operating system capable of performing automatic opening and logging in of a website, so as to perform the automatic opening and logging in of a website; and
(1-7) driving the specific software through the first or the second program.

3. The method of automatically logging in a website as claimed in claim 1, wherein the step (2) further comprises the following steps:
(2-1) detecting through the specific software for any related data, with which the operating system automatically opens and logs in a related website; if no related data being detected, going to step (2-2); and if any related data being detected, going to step (2-9);
(2-2) displaying an interface for entering data enabling linking to the related website;
(2-3) manually entering by a user on the interface the data required to link to the website; procedures for login being immediately performed and a web page of the website to be logged in being displayed immediately;
(2-4) displaying an interface for entering further information about user, with which the user is admitted to an authorized-only web page of the website;
(2-5) testing whether the entered further information about user is correct or not; if yes, going to step (2-6); and if not, going to step (2-4) again;
(2-6) storing the data for linking to the related website and the further information about user in the externally connected removable storage device or the computer system;
(2-7) checking and determining whether there is still any other new data for linking to other related website and any other further information about user to be entered; if yes, going to step (2-2) again; and if not, going to step (2-8);
(2-8) determining whether an immediate login of the desired website is to be done or not; if yes, going to step (2-9); and if not, going to step (3);
(2-9) loading the data for linking to website and the further information about user from the externally connected removable storage device or the computer system; and
(2-9A) automatically displaying at least one desired website, and immediately automatically inputting the further information about user to log in the website.

4. The method of automatically logging in a website as claimed in claim 1, wherein the removable storage device is selected from the group consisting of USB mass storage devices, personal digital apparatus, and general CD-ROM's.

5. The method of automatically logging in a website as claimed in claim 1, wherein the computer system is selected from the group consisting of desktop computers, notebook computers, and personal digital assistants.

6. The method of automatically logging in a website as claimed in claim 2, wherein the operating system is selected from the group consisting of Windows 98™, Windows Me™, Windows 2000™, and Windows XP™.

7. The method of automatically logging in a website as claimed in claim 3, wherein the operating system is selected from the group consisting of Windows 98™, Windows Me™, Windows 2000™, and Windows XP™.

8. The method of automatically logging in a website as claimed in claim 3, wherein the further information about user includes any one of the following items: username, user-specified password, and both user name and user-specified password.

9. The method of automatically logging in a website as claimed in claim 8, wherein the user name and the user-specified password vary from website to website.
